(19) United States
(12) Patent Application Publication
(10) Pub. No.: US 2018/0221928 A1
(43) Pub. Date: Aug. 9, 2018

(54) MAGNETIC DISC ALUMINUM ALLOY SUBSTRATE AND MANUFACTURING METHOD THEREFOR

(71) Applicants: UACJ CORPORATION, Tokyo (JP); FURUKAWA ELECTRIC CO., LTD., Tokyo (JP)

(72) Inventors: Kotaro Kitawaki, Tokyo (JP); Takuya Murata, Tokyo (JP); Akira Hibino, Tokyo (JP); Naoki Kitamura, Tokyo (JP); Hiroki Ota, Tokyo (JP); Hideki Takahashi, Tokyo (JP); Takashi Mori, Tokyo (JP)

(21) Appl. No.: 15/747,681

(22) PCT Filed: Jul. 27, 2016
(86) PCT No.: PCT/JP2016/072027

§ 371 Date: Jan. 25, 2018

(30) Foreign Application Priority Data
Jul. 28, 2015 (JP) 2015-148298
Jul. 21, 2016 (JP) 2016-143017

(51) Int. Cl. B21B 3/00; B22D 1/00; C22C 21/08; C22F 1/047; G11B 5/73; G11B 5/84

(52) U.S. Cl. CPC B21B 3/003; B22D 1/002; C22C 21/08; B21B 2003/001; G11B 5/73; G11B 5/84; C22F 1/047

(57) ABSTRACT

Disclosed are an aluminum alloy substrate for a magnetic disc, which includes an aluminum alloy consisting of Mg:4.5-10.0 mass % (hereinafter referred to as %), Be: 0.00001-0.00200%,Cu: 0.003-0.150%, Zn: 0.05-0.60%, Cr: 0.010-0.300%, Si: 0.060% or less, and Fe: 0.060% or less, with a balance being Al and an unavoidable impurity, an amount of an Mg-based oxide being 50 ppm or less, (I_{Be}/I_{bulk})×(C_{Be})≤0.1000% where (I_{Be}) is a maximum optical emission intensity of Be in a surface depth direction using a glow discharge optical emission spectrometer (GDS) prior to performing a plating pretreatment, (I_{bulk}) is a mean optical emission intensity of Be in an interior of a base material of the aluminum alloy prior to performing a plating pretreatment, and (C_{Be}) is an amount of the Be, and a method of manufacturing the magnetic disc aluminum alloy substrate.

### TECHNICAL FIELD

The present disclosure relates to an aluminum alloy substrate for a magnetic disc excellent in smoothness of a plated surface and strength and a method for manufacturing the same.

### BACKGROUND ART

Aluminum alloy magnetic discs used for computer storage devices are manufactured based on JIS 5086 (3.5 mass % or more and 4.5 mass % or less of Mg, 0.50 mass % or more of Fe, 0.40 mass % or less of Si, 0.20 mass % or more and 0.70 mass % or less of Mn, 0.05 mass % or more and 0.25 mass % or less of Cr, 0.10 mass % or less of Cu, 0.15 mass % or less of Ti, 0.25 mass % or less of Zn, a balance Al and unavoidable impurities), which has an excellent plating property and is excellent in mechanical property and workability. Further, aluminum alloy magnetic discs are manufactured by an aluminum alloy substrate with intermetallic compounds reduced by limiting the amounts of contained impurities, such as Fe, Si and Mn, in JIS 5086 for the purpose of dealing with a trouble caused by pits originated from falling-off of intermetallic compounds in the plating pretreatment process, or an aluminum alloy substrate intentionally doped with Cu or Zn in JIS 5086 for the purpose of improving the plating property, and the like.

In a general aluminum alloy magnetic disc, first, an aluminum alloy plate is produced, then an annular aluminum alloy substrate (disc blank) is produced, cut and polished, and then annealed to yield an aluminum alloy substrate. Subsequently, plating is applied to the aluminum alloy substrate, and a magnetic material is deposited onto the surface of the aluminum alloy substrate.

For example, an aluminum alloy magnetic disc using the JIS 5086 alloy is manufactured through the following manufacturing process. First, an aluminum alloy having a desired chemical composition is cast into an ingot, which is in turn hot rolled, and then subjected to cold rolling to prepare a rolled material having a required thickness as a magnetic disc. The rolled material is annealed, as needed, during cold rolling or the like. Next, this rolled material is punched in an annular shape, and, in order to remove the distortion and the like caused by the manufacturing process, an annular aluminum alloy plate is laminated, and is subjected to pressurized annealing to be annealed while being pressurized from both sides for flattening, yielding a disc blank.

After the disc blank produced in this way is subjected to cutting and polishing as pretreatment, the disc blank is heated to remove distortion or the like caused through the processing step, thus providing an aluminum alloy substrate. Next, degreasing, etching, and a zincate treatment (Zn substitution treatment) are carried out as a plating pretreatment, and further, electroless plating of Ni—P, which is a hard nonmagnetic metal, is carried out as a surface treatment. Finally, the Ni—P electroless plated surface is polished, and then a magnetic material is sputtered thereon to produce an aluminum alloy magnetic disc.

Incidentally, in recent years, magnetic discs are required to have larger capacities and higher densities due to the needs of multimedia and the like. In order to further increase the capacity, the number of magnetic discs mounted on the storage device is increasing, which requires making the magnetic discs thinner. However, reducing the thickness of the aluminum alloy substrate for a magnetic disc lowers the strength, which necessitates an increase in the strength of the aluminum alloy substrate.

On the other hand, further increasing the recording density of the magnetic disc requires that the floating height of the magnetic head with respect to the magnetic disc be made lower, and the distance between the magnetic disc and the magnetic head be made more stable. For this purpose, high smoothness is required for the Ni—P plated surface of the aluminum alloy substrate for a magnetic disc.

In addition, the increased density of the magnetic discs results in further miniaturization of the magnetic area per 1 bit, so that even the presence of minute pits (holes) on the plated surface of a magnetic disc may cause an error at the time of reading data. For this reason, the plated surface of the magnetic disc is required to have fewer pits to provide high smoothness.

In view of such circumstances, in recent years, there are strong demands for aluminum alloy substrates for magnetic discs that have an enhance strength and are excellent in the smoothness of the plated surface, and a study has been made on such aluminum alloy substrates. For example, Patent Literature 1 has proposed a method for manufacturing an Al substrate for a high-strength magnetic disc by adding 0.05 to 1 weight % of Mn to an Al—Mg based alloy and setting the working ratio of the final cold rolling to 10 to 50%, the recrystallization temperature of the aluminum alloy substrate, providing an unrecrystallized structure with an enhanced strength. Patent Literature 2 has proposed a method of improving the strength of an aluminum alloy plate and the smoothness of the Ni—P plated surface by increasing the amount of Mg content which contributes to the improvement of the strength of the aluminum alloy plate and controlling the sizes of the Al—Fe based and the Mg—Si type based intermetallic compounds.

However, according to the method disclosed in Patent Literature 1, the amount of Mn added is large, so that a lot of coarse Al—Fe-Mn based intermetallic compounds are present on the surface of the aluminum alloy substrate, and are dropped off during a plating pretreatment, producing a large depression, which impairs the smoothness of the plated surface.

Further, mere limiting of the sizes of the intermetallic compounds (Al—Fe based and Mg—Si based) disclosed in Patent Literature 2 prevents formation of pits having a maximum diameter of 1 μm or more produced on the Ni—P the plated surface (hereinafter referred to as “conventional pits,” which also refers to pits produced due to poor adhesion of the zincate film or plating), but may not prevent formation of minute pits having a maximum diameter of 0.5 μm or more and less than 1 μm (hereinafter referred to as “micropits”), and, at present, the intended high smoothness of the Ni—P plated surface has not been provided.

### CITATION LIST

### Patent Literature

Patent Literature 1: Unexamined Japanese Patent Application Kokai Publication No. S63-223150.

Patent Literature 2: Unexamined Japanese Patent Application Kokai Publication No. 2006-241513

### SUMMARY OF INVENTION

### Technical Problem

The present disclosure has been made in view of the above circumstances, and an objective of the present disclosure is to provide an aluminum alloy substrate for a magnetic disc which is excellent in smoothness of a the plated surface and strength.

### Solution to Problem

That is, an aluminum alloy substrate for a magnetic disc according to the present disclosure as set forth in claim 1 includes an aluminum alloy consisting of Mg: 4.5 to 10.0 mass %, Be: 0.00001 to 0.00200 mass %, Cu: 0.003 to 0.150 mass % , Zn: 0.05 to 0.60 mass %, Cr: 0.010 to 0.300 mass %, Si: 0.060 mass % or less, and Fe: 0.060 mass % or less, with a balance being Al and unavoidable impurities, an amount of an Mg-based oxide being 50 ppm or less, (I_{Be}/I_{bulk})×(C_{Be})≤0.1000 mass % where (I_{Be}) is a maximum optical emission intensity of Be in a surface depth direction using a glow discharge optical emission spectrometer (GDS) prior to performing a plating pretreatment, (I_{bulk}) is a mean optical emission intensity of Be in an interior of a base material of the aluminum alloy prior to performing a plating pretreatment, and (C_{Be}) is an amount of the Be.

A method of manufacturing an aluminum alloy substrate for a magnetic disc according to the present disclosure as set forth in claim 2 is a method of manufacturing an aluminum alloy substrate for a magnetic disc according to claim 1, comprising:

a preparing step of preparing a molten metal of the aluminum alloy;

a molten-metal holding step of heating and holding the prepared molten metal of the aluminum alloy;

a casting step of casting the heated and held molten metal;

a hot rolling step of hot rolling an ingot;

a cold rolling step of cold rolling a hot rolled plate;

a machining step of machining the cold rolled plate into an annular disc;

a pressure flattening and annealing step of pressurizing and flattening the annular disc to yield a disc blank;

a cutting and polishing step of cutting and polishing the disc blank; and

a straightening heat treatment step of cutting and polishing the cut and polished disc blank,

wherein

in the molten-metal holding step, the molten metal of the aluminum alloy is heated and held in a holding furnace at a holding temperature in a range of 700 to 850° C. for 0.5 and more and less than 6.0 hours, a time from end of the molten-metal holding step to start of the casting step being 0.3 hours or less, a time from start of the molten-metal holding step to start of the casting step is 6.0 hours or less,

in the casting step, the molten metal is cast with a temperature of the molten metal at start of the casting being set to 700 to 850° C., and

the straightening heat treatment step includes a heating and temperature raising stage of heating the disc blank at a temperature raising rate of 20.0° C/min or more from 150° C. to the holding temperature in the range to 200 to 400° C., a heating and holding stage of heating and holding the disc blank at the holding temperature for 5 to 15 minutes, and a cooling and temperature-lowering stage of cooling the disc blank at a temperature falling rate of 20.0° C/min or more from the holding temperature to 150° C.

Further, a magnetic disc according to the present disclosure as set forth in claim 3 is characterized in that plating and a magnetic material are provided on the aluminum alloy substrate for the magnetic disc according to claim 1.

### Advantageous Effects of Invention

The aluminum alloy substrate for a magnetic disc and the method of manufacturing the same according to the present disclosure exerts a special effect that the plated surface is excellent in smoothness and strength.

### BRIEF DESCRIPTION OF DRAWINGS

FIG. 1 is a flowchart showing a process of manufacturing an aluminum alloy substrate for a magnetic disc, a surface-treated aluminum alloy substrate for a magnetic disc, and a magnetic disc according to the present disclosure; and

FIG. 2 is a graph showing an example of GDS analysis in the depth direction of the surface of the aluminum alloy substrate for a magnetic disc according to the present disclosure.;

### DESCRIPTION OF EMBODIMENTS

The inventors of the present disclosure has focused attention on the strength and smoothness of the plated surface of a surface-treated aluminum alloy substrate for magnetic discs, and have intensively studied the relationship between these properties and the components and the structure of the aluminum alloy substrate for a magnetic disc. As a result, the inventors of the present disclosure have found that the Al/Mg/Be oxide in the surface layer of the aluminum alloy substrate for a magnetic disc and the Mg-based oxide in the aluminum alloy substrate significantly affect the smoothnesses of the plated surfaces provided by the micropits and the conventional pits. Based on these findings, the present inventors have made the present disclosure.

The following describes an aluminum alloy substrate for a magnetic disc according to an example embodiment of the present disclosure in detail.

1. Aluminum Alloy Composition

First, the aluminum alloy components of the aluminum alloy substrate for a magnetic disc according to the example embodiment of the present disclosure will be described.

Magnesium:

Mg has an effect of mainly improving the strength of the aluminum alloy substrate. In addition, Mg exerts an action of uniformly, thinly and densely adhering the zincate film during the zincate treatment, so that in the surface plating treatment step, which follows the zincate treatment step, the smoothness of the plated surface made of Ni—P is improved. The Mg content is 4.5 to 10.0 mass % (hereinafter simply referred to as “%”). When the Mg content is less than 4.5%, the strength is insufficient, whereas when the Mg content exceeds 10.0%, coarse Mg—Si based compounds are formed, and at the time of etching, the zincate treatment, and cutting and polishing, a coarse Mg—Si compounds fall off, forming large pits (conventional pits) on the plated surface. As a result, the smoothness of the plated surface is impaired. The preferable Mg content is 4.5 to 7.0% from the balance of strength and ease of production.

Beryllium:

At the time of casting, Be has an effect of suppressing oxidation of a molten metal of Mg and an effect of improving the corrosion resistance of the material itself. However, when the amount of Be added is large, Be is segregated at the surface layer in the straightening heat treatment after cutting/polishing processing, and the Be-contained Al/Mg/Be oxide is formed. It was found that when plating was applied to the aluminum alloy substrate, many micropits having a smaller size than that of the conventional pits were formed on the plated surface. This seems to be related to the Be-contained

Al/Mg/Be oxide having a high corrosion resistance compared to an Al/Mg oxide that does not contain Be. That is, the high corrosion resistance of the Al/Mg/Be oxide seems to make it difficult to remove the Al/Mg/Be oxide through the plating pretreatment such as etching.

The thickness of the Al/Mg/Be oxide formed on such a surface layer is not necessarily uniform, and a difference in thickness is provided by the formation of a thick (large surface segregation of Be) part and a thin part (small surface segregation of Be) on the surface layer. At the part where the surface segregation of Be is high, the thickness of the Al/Mg/Be oxide is increased by the plating pretreatment such as the etching treatment, so that the Al/Mg/Be oxide is not completely removed, and partly remains.

As a result, it is considered that a cathode reaction occurs on the Al/Mg/Be oxide during plating and an anode reaction (dissolution of the Al matrix) occurs around the Al/Mg/Be oxide. Further, in the part where this Al/Mg/Be oxide partially remains, dissolution of the Al matrix continues during plating, and a micro dent centering on the Al/Mg/Be oxide is formed. It is considered that in this recessed part, the continuous dissolution of the Al matrix makes it difficult for the plating to adhere, resulting in the formation of micropits on the plated surface. The conventional pits, which have been problematic in the past, are formed as Al—Fe based compounds and the like dissolve during the plating pretreatment, forming huge recesses in the Al matrix, and the huge recesses are not filled up through the plating. However, micropits originated from the Al/Mg/Be oxide are characterized in that although the recesses formed in the Al matrix are minute, the continuous dissolution of the Al matrix forms micropits.

Thus, when the Be content is small, the Al/Mg/Be oxide becomes thin, so that the Al/Mg/Be oxide is removed in the plating pretreatment. On the other hand, when the Be content is large, the Al/Mg/Be oxide becomes thick, so that the Al/Mg/Be oxide is not completely removed and partly remains in the plating pretreatment. As a result, micropits are formed, so that it appears that the greater the number of the parts where the difference in thickness of the Al/Mg/Be oxide is large, the greater the quantity of micropits formed.

On the other hand, when the amount of Be added is small, a lot of Mg-based oxides are produced. It was revealed that, as a result, when plating was performed, micropits having a size smaller than that of the conventional pits would be formed on the plated surface. It is thought that the Mg-based oxide dissolves during plating and the Mg ions dissolved out influence the formation of micropits. That is, it appears that since the Mg-based oxide has high solubility in the plating liquid, the Mg-based oxide dissolves during plating to elute the Mg ions, making adhesion of plating difficult, and thus resulting in the formation of micropits.

The Be content is 0.00001 to 0.00200%. When it is less than 0.00001%, a lot of Mg-based oxides are formed, and micropits having a size smaller than that of conventional pits are formed on the plated surface during plating, and the smoothness of the plated surface is impaired. On the other hand, when it exceeds 0.00200%, a thick Al/Mg/Be oxide is formed at the time of heating after polishing, so that micropits are produced at the time of plating and the smoothness of the plated surface is impaired. The preferable Be content is 0.00010 to 0.00170%.

Copper:

Cu reduces has an effect of reducing the amount of Al dissolved in the zincate treatment and an effect of uniformly, thinly and densely adhering the zincate film. As a result, the smoothness of the plated surface made of Ni—P formed in the subsequent step, namely, the surface plating treatment is improved. The Cu content is 0.003 to 0.150%. When the Cu content is less than 0.003%, the above effects may not be provided sufficiently. On the other hand, when the Cu content exceeds 0.150%, coarse Al—Cu—Mg—Zn intermetallic compounds are formed, and conventional pits are formed after the plating and the smoothness is impaired. Furthermore, since the corrosion resistance of the material itself is lowered, the zincate film formed through the zincate treatment becomes nonuniform, and the adhesion and smoothness of the plating are impaired. The preferable Cu content is 0.005 to 0.100%.

Zinc:

Like Cu, Zn has an effect of reducing the amount of Al dissolved in the zincate treatment, making the zincate film uniformly, thinly and densely adhered, and thus improving the smoothness of the plated surface made of Ni—P formed in the subsequent step, namely, the surface plating treatment. The Zn content is 0.05 to 0.60%. When the Zn content is less than 0.05%, the above effect may not be provided sufficiently. On the other hand, when the Zn content exceeds 0.60%, coarse Al—Cu—Mg—Zn intermetallic compounds are formed, and conventional pits after the plating process are produced, resulting in a decrease in smoothness. Furthermore, it lowers workability and corrosion resistance of the material itself. A preferable Zn content is 0.05 to 0.50%.

Chromium:

Cr produces fine intermetallic compounds during casting, but partly forms a solid solution in the matrix to contribute to the enhancement of the strength. It also has an effect of increasing the machinability and polishability, further refining the recrystallized structure, and improving the adhesion of the plating layer. The Cr content is 0.010 to 0.300%. When the Cr content is less than 0.010%, the above effect may not be provided sufficiently. On the other hand, when the Cr content exceeds 0.300%, the excessive amount is crystallized at the time of casting, and at the same time coarse Al—Cr intermetallic compounds are produced at the time of etching, at the time of the zincate treatment, at the time of cutting or polishing. The coarse Al—Cr intermetallic compounds fall off, causing large conventional pits to be formed on the plated surface, and the smoothness of the plated surface is impaired. The preferable Cr content is 0.010 to 0.200%.

Silicon:

Since Si bonds with Mg, which is an essential element of the present disclosure, to form intermetallic compounds that become a defect in the plating layer, it is not preferable that Si is contained in the aluminum alloy. When the Si content exceeds 0.060%, coarse Mg—Si intermetallic compounds are formed, which causes the formation of conventional or the like. Therefore, the Si content is controlled to be 0.060% or less. The Si content is preferably controlled to be less than 0.025%, most preferably 0%.

Iron:

Fe hardly dissolves in aluminum and exists as Al—Fe intermetallic compounds in aluminum bronze. Since Fe present in the aluminum bonds with Al, which is an essential element of the present disclosure, to form intermetallic compounds that become a defect in the plating layer, it is not preferable that Fe is contained in the aluminum alloy. When the Fe content exceeds 0.060%, coarse Al—Fe intermetallic compounds are formed, which causes the generation of conventional pits or the like. Accordingly, the Fe content is controlled to be 0.060% or less. The Fe content is preferably controlled to be less than 0.025%, most preferably 0%.

Other Elements:

The balance of the aluminum alloy according to the example embodiment of the present disclosure includes aluminum and unavoidable impurities. Here, if the unavoidable impurities (for example, Mn) are each 0.03% or less and are 0.15% or less in total, the property as the aluminum alloy substrate provided in the present disclosure is not impaired.

2. Segragation State of Be at the Surface Layer of Aluminum Alloy Substrate for Magnetic Disc

Next, the segregation state of Be at the surface layer of the aluminum alloy substrate for a magnetic disc according to the present disclosure will be described.

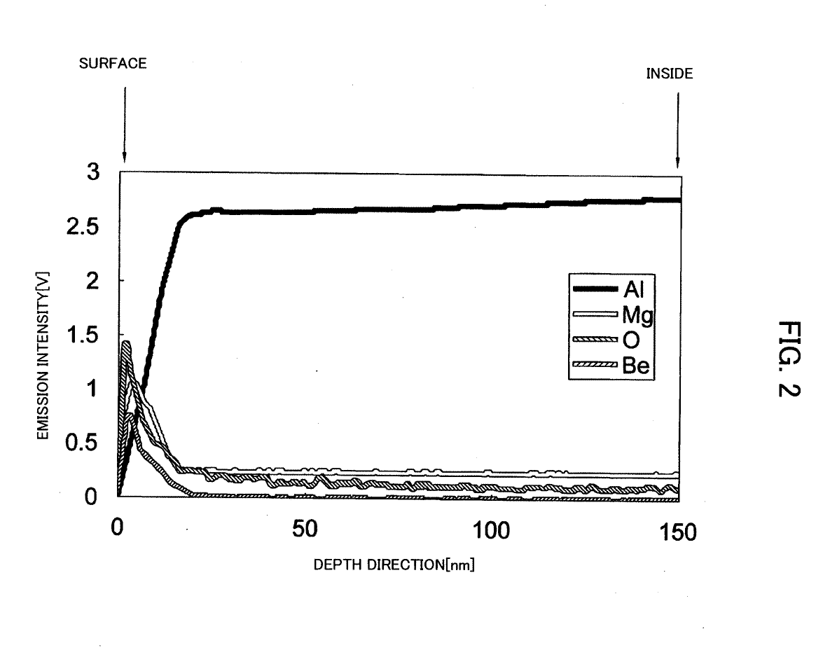

As shown in FIG. 2, the segregation state of Be at the surface layer of an aluminum alloy substrate for a magnetic disc (an aluminum alloy substrate subjected to a straightening heat treatment and before plating pretreatment, which will be described later) may be evaluated by performing analysis in a surface depth direction with a glow discharge emission optical emission spectrometer (GDS). When (I_{Be}/I_{bulk})×(C_{Be}), the product of (I_{Be}/I_{bulk}), which is the ratio between the maximum emission intensity (Be) of Be when analyzed by GDS and the average Be intensity (I_{bulk}) inside the base material of the aluminum alloy substrate, and the Be concentration C_{Be} (%) is 0.1000% or less, due to the Al/Mg/Be oxide in the surface layer of the aluminum alloy substrate being thin, the Al/Mg/Be oxide is removed, which may suppress the formation of pits. On the other hand, when the ratio (I_{Be}/I_{bulk})×(C_{Be}) exceeds 0.1000%, the Al/Mg/Be oxide is not completely removed and remains through the plating pretreatment because of the thick Al/Mg/Be oxide, forming many micropits. Therefore, this (I_{Be}/I_{bulk})×(C_{Be}) is defined to be 0.1000% or less. It is preferable that this (I_{Be}/I_{bulk})×(C_{Be}) is controlled to be 0.0500% or less. While the lower limit of (I_{Be}/I_{bulk})×(C_{Be}) is determined depending on the composition of the aluminum alloy and the manufacturing method, it is preferably 0.0010%, more preferably 0.0001% in the present disclosure.

In the present disclosure, in the GDS measurement of the surface layer of the aluminum alloy substrate, the maximum emission intensity (I_{Be}) of Be is the maximum value of the Be emission intensity when measured from the outermost layer of the aluminum alloy substrate to a depth of 2.0 μm. The average Be intensity (I_{bulk}) inside the base material of the aluminum alloy substrate is an average value of Be emission intensity at a depth of 1.5 μm to 2.0 μm from the outermost layer of the aluminum alloy substrate.

3. Amount of Mg-based Oxide

Next, the amount of the Mg-based oxide in the aluminum alloy substrate for a magnetic disc according to the present disclosure will be described.

When the amount of the Mg-based oxide in the aluminum alloy substrate exceeds 50 ppm, a lot of micropits having a size smaller than that of the conventional pits are formed on the plated surface during plating, impairing the smoothness of the plated surface. Accordingly, the amount of the Mg-based oxide is controlled to be 50 ppm or less. The Mg content-based oxide is preferably controlled to be 10 ppm or less, most preferably 0 ppm. In the present disclosure, the Mg-based oxide refers to oxides containing Mg in MgO and Al₂MgO₄. The amount of Mg-based oxide in the aluminum alloy substrate is measured by the iodine methanol method, that is, the oxide extraction method.

4. Method for Manufacturing Aluminum Alloy Substrate for Magnetic Disc

The following describes the steps of manufacturing the aluminum alloy substrate for a magnetic disc according to the present disclosure in detail.

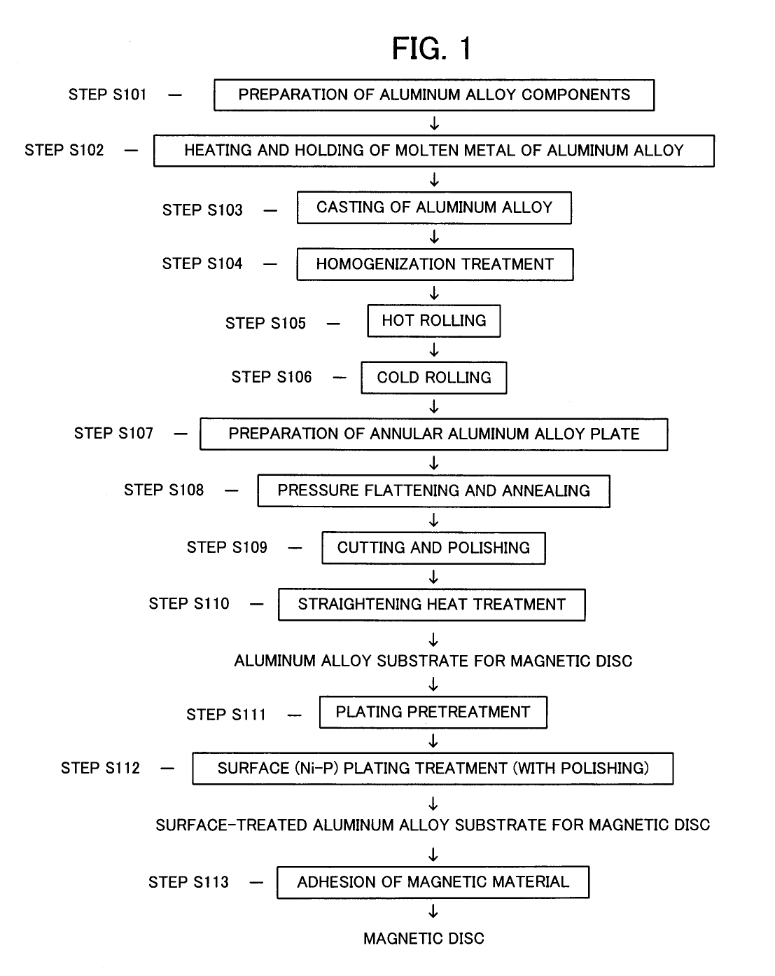

A method of manufacturing an aluminum alloy substrate for a magnetic disc will be described with reference to a flowchart shown in FIG. 1. Here, the preparation of the aluminum alloy components (step S101) to the straightening heat treatment (step S110) are the steps of manufacturing the aluminum alloy substrate for a magnetic disc according to the present disclosure. Then, the plating pretreatment (step S111) and the subsequent surface (Ni—P) plating treatment (step S112) are performed on the aluminum alloy substrate for a magnetic disc to prepare the surface-treated aluminum alloy substrate for a magnetic disc according to the present disclosure is prepared. Further, a magnetic disc is prepared by adhering a magnetic material to the surface of the surface-treated aluminum alloy substrate for the magnetic disc (step S113). First, a process of manufacturing an aluminum alloy substrate for a magnetic disc will be described.

The molten metal of the aluminum alloy having the above composition is controlled through heating and melting according to the conventional method (step S101). Next, the molten metal of the controlled aluminum alloy is heated and held in a holding furnace (step S102).

Setting the heating temperature of the molten metal in the holding furnace to 700 to 850° C. makes it possible to suppress the formation of the Mg-based oxide and the formation of inclusions. When the heating temperature of the molten metal in the holding furnace is less than 700° C., a lot of inclusions are formed during holding, and even if an inclusion is kept at such a temperature of less than 700° C. for a long time, this inclusion is sufficiently removed and may remain in the molten aluminum alloy. As a result, large depressions and polishing scratches are formed on the substrate surface due to the presence of the inclusions, and the smoothness of the plated surface is impaired. On the other hand, when the heating temperature of the molten metal in the holding furnace exceeds 850° C., a lot of Mg-based oxides are produced, and when plating is performed, a lot of micropits having a smaller size than that of the conventional pits are formed on the plated surface. Therefore, the heating temperature of the molten metal in the holding furnace is 700 to 850° C. The preferred heating temperature of the molten metal in the holding furnace is 750 to 850° C.

Setting the holding time of the molten metal in the holding furnace to 0.5 hour or more and less than 6.0 hours may suppress the formation of the Mg-based oxide, and inclusions (Ti—V—Zr—B based particles and the like) may be precipitated and removed. The holding time for the molten metal in the holding furnace means the time during which the molten aluminum alloy controlled in the melting furnace is all transferred to the holding furnace and the holding time after the treatment such as degassing in the furnace is performed. When the holding time for the molten metal in the holding furnace is less than 0.5 hour, precipitation of the inclusions is insufficient and remains in the molten aluminum alloy. As a result, the presence of the inclusions causes large depressions and polishing scratches to be produced on the substrate surface, and the smoothness of the plated surface is impaired. On the other hand, when the holding time of the molten metal in the holding furnace is 6.0 hours or more, a lot of Mg-based oxides are formed, and when plating is performed, micropits having a smaller size than that of the conventional pits are formed on the plated surface. Accordingly, the holding time for the molten metal in the holding furnace is set to 0.5 hour or more and less than 6.0 hours. Also, the holding time for the molten metal in the preferred holding furnace is 0.5 hour or more and 3.0 hours or less.

After maintaining the molten metal in the holding furnace, it is preferable to carry out an in-line degasification treatment or an in-line filtration treatment according to the conventional method before casting. Commercially available apparatuses such as those available under the trademarks of SNIF and ALPUR may be available as the in-line degas processing apparatus. The in-line degas processing apparatuses are designed to rotate the bladed rotary body at a high speed to feed the gas as minute bubbles into the molten metal while blowing a argon gas or a gas mixture of argon and nitrogen or the like into the molten metal,. As a result, dehydrogenation gas and inclusions may be removed in-line in a short time. In the in-line filtration treatment, a ceramic tube filter, a ceramic foam filter, an alumina ball filter or the like is used, and inclusions are removed by a cake filtration mechanism or a filter material filtration mechanism.

When the molten metal is held in the holding furnace and the degasification treatment and filtration treatment are performed in-line, the temperature of the molten metal sometimes decreases. Therefore, the temperature of the molten metal at the start of casting is also set to 700 to 850° C. as well as the heating temperature of the molten metal in the holding furnace. When the temperature of the molten metal at the start of casting is less than 700° C., many of the inclusions are produced before casting starts. As a result, the presence of the inclusions causes large depressions and polishing scratches to be produced on the substrate surface, and the smoothness of the plated surface is impaired. On the other hand, when the temperature of the molten metal at the start of casting exceeds 850° C., a lot of Mg-based oxides are produced, and when plating is performed, micropits having a smaller size than that of the conventional pits are formed on the plated surface. Accordingly, the temperature of the molten metal at the start of casting is set to 700 to 850° C. The preferred temperature of the molten metal at the start of the casting is 700 to 800° C.

Also, if it takes time to cast the molten metal after holding the molten metal in the holding furnace, a lot of Mg-based oxides are produced. Therefore, the time from holding of the molten metal in the holding furnace to the start of casting (the time from the end of the molten-metal holding step to the start of the casting step) is set to 0.3 hour or less, and the time from the holding of the molten metal to the start of casting (the time from the start of the molten-metal holding step to the start of the casting step) is set to 6.0 hours or less. When the time until the start of casting exceeds 0.3 hours and the time from holding of the molten metal to the start of casting exceeds 6.0 hours, a lot of Mg-based oxides are produced, and when plating treatment is performed, many micropits, which are smaller in size than the conventional pits, are produced. Therefore, the time from holding the molten metal in the holding furnace to the start of casting shall be 0.3 hours or less, and the time from holding the molten metal to the start of casting shall be 6.0 hours or less. The preferable time until the start of casting is 0.1 hour or less, and the preferable time from the holding of the molten metal to the start of casting is 3.1 hours or less.

Next, the molten metal of the aluminum alloy heated and maintained is degassed and an aluminum alloy is cast by a semi-continuous casting method (DC casting method), a continuous casting method (CC method) or the like (step S103).

Next, a homogenization treatment is applied to the ingot of the cast aluminum alloy (step S104). Although it is not necessary to perform the homogenization treatment, in the case of carrying out the treatment, it is preferable to carry out at 480 to 560° C. for 1 hour or more, more preferably at 500 to 550° C. for 2 hours or more. When the treatment temperature is less than 480° C. or the treatment time is less than 1 hour, sufficient homogenizing effect may not be provided in some cases. Also, at the treatment temperature exceeding 560° C., there is a possibility that the material is dissolved.

Next, an ingot of the cast aluminum alloy or an ingot of a homogenized aluminum alloy in the case of homogenization treatment is formed into a plate material by hot rolling (step S105). Conditions for hot rolling are not particularly limited, but the hot rolling start temperature is preferably 300 to 500° C., and more preferably 320 to 480° C. Further, the hot rolling finish temperature is preferably 260 to 400° C., and more preferably 280 to 380° C. When the hot rolling start temperature is less than 300° C., the hot rolling processability may not be secured, and when it exceeds 500° C., the crystal grains become coarse and the adhesion of the plating may decrease in some cases. Hot rolling processability may not be ensured when the hot rolling finish temperature is lower than 260° C., and crystal grains are coarsened when the temperature exceeds 400° C., the adhesion of the plating decreases in some cases. In the hot rolling treatment, hot rolling is usually carried out after maintaining the ingot at the hot rolling start temperature for 0.5 to 10.0 hours. In the case of performing the homogenization treatment, the heating retention may be replaced with the homogenization treatment.

Next, the hot rolled plate is cold rolled to obtain an aluminum alloy plate of preferably 0.4 to 2.0 mm, more preferably 0.6 to 2.0 mm (step S 106). That is, after the end of hot rolling, the aluminum alloy plate is finished to the required product thickness through cold rolling. The conditions for the cold rolling are not particularly limited, and may be determined according to the required product plate strength and plate thickness, the rolling reduction is preferably 20 to 90%, more preferably 20 to 80% is more preferable. When this rolling reduction is less than 20%, the crystal grains are coarsened by pressure flattening and annealing in some cases, and the adhesion of the plating may be deteriorated in some cases. When this rolling ratio exceeds 90%, the production time is prolonged, which may result in a decrease in manufacturability.

In order to ensure good cold rolling workability, annealing treatment may be performed before cold rolling or during cold rolling. In the case of performing annealing, for example, in batch type annealing, it is preferable to carry out the annealing at 300 to 450° C. for 0.1 to 10 hours, and under 300 to 380° C. for 1 to 5 hours more preferable. When the annealing temperature is less than 300° C. or the annealing time is less than 0.1 hour, a sufficient annealing effect may not be provided in some cases. In addition, when the annealing temperature exceeds 450° C., the crystal grains become coarse and the adhesion of the plating may decrease, and when the annealing time exceeds 10 hours, the productivity decreases. On the other hand, in continuous annealing, it is preferable to carry out the annealing at 400 to 500° C. for 0 to 60 seconds, more preferably at 450 to 500° C. for 0 to 30 seconds. When the annealing temperature is less than 400° C., a sufficient annealing effect may not be provided in some cases. On the other hand, when the annealing temperature exceeds 500° C., the crystal grains become coarse and the adhesion of the plating may be deteriorated. When the annealing time exceeds 60 seconds, the crystal grains become coarse and the adhesion of the plating which may degrade the quality. In this case, 0 second means to cool down immediately after reaching a desired annealing temperature.

In order to process the thus obtained aluminum alloy plate as an aluminum alloy substrate for a magnetic disc, first, an aluminum alloy plate is punched in an annular shape to produce an annular aluminum alloy plate (step S107). Next, the annular aluminum alloy plate is subjected to pressure flattening and annealing in the air at 300 to 450° C. for 30 minutes or more, preferably 300 to 380° C. for 60 minutes or more to prepare a flattened disc blank (step S108). When the treatment temperature is less than 300° C. or the treatment time is less than 30 minutes, the flattening effect may not be provided in some cases. When the treatment temperature exceeds 450° C., the crystal grains become coarse and the adhesion of the plating may decrease in some cases. The pressurization is usually carried out under a pressure of 1.0 to 3.0 MPa.

Next, after cutting and polishing the flattened disc blank (step S109), a heating process (step S110) for straightening the disc blank is performed.

In the case where the rate of temperature increases from 150° C. to the holding temperature in the range of 200 to 400° C. is less than 20.0° C/min during heating up of the straightening heat treatment, the Al/Mg/Be oxide in the surface layer of the aluminum alloy substrate becomes thick. As a result, the Al/Mg/Be oxide is not completely removed and remains through the plating pretreatment, forming a lot of micro pits. Therefore, this heating rate is set to 20.0° C/min or more. The heating rate is preferably 30.0° C/min or more. Although the upper limit value of the heating rate is not particularly limited, the upper limit value depends on the heating capacity of the apparatus, and is preferably 60.0° C/min in the present disclosure. The reason for prescribing the heating rate from 150° C. is that even if it is held for a long time in a temperature range of less than 150° C., the segregation of Be is not greatly influenced.

When the holding temperature in the heat treatment is less than 200° C., the processing strain is not removed so that the substrate is deformed during heating after plating (for example, heating by magnetic sputtering) and may not be used as a magnetic disc. On the other hand, when the holding temperature exceeds 400° C., the Al/Mg/Be oxide in the surface layer of the aluminum alloy substrate becomes thick, so that the Al/Mg/Be oxide is not completely removed and remains through the plating pretreatment, forming a lot of micropits. Accordingly, the holding temperature is set to 200 to 400° C. The preferable holding temperature is 200 to 290° C.

When the holding time at the holding temperature is less than 5 minutes, the processing strain is not removed, so that the substrate cannot be used as a magnetic disc due to deformation of the substrate at the time of heating after plating treatment (for example, heating by magnetic sputtering). On the other hand, when the holding time exceeds 15 minutes, since the Al/Mg/Be oxide in the surface layer of the aluminum alloy substrate becomes thick, the Al/Mg/Be oxide is not completely removed and remains through the plating pretreatment, a lot of micropits are formed. Therefore, the holding time is 5 to 15 minutes. The preferable holding time is 5 to 10 minutes.

When the temperature falling rate from the holding temperature in the range of 200 to 400° C. to 150° C. is less than 20.0° C/min during cooling down of the straightening heat treatment, the Al/Mg/Be oxide in the surface layer of the aluminum alloy substrate becomes thick. As a result, the Al/Mg/Be oxide is not completely removed and remains through the plating pretreatment, and a lot of micro pits are formed. Therefore, this temperature falling rate is set to 20.0° C/min or more. The temperature falling rate is preferably 30.0° C/min or more. The upper limit value of the temperature falling rate is not particularly limited, and the upper limit value depends on the cooling capacity of the apparatus, but is preferably 60.0° C/min in the present disclosure. Further, the reason why the temperature falling rate is defined as 150° C. is as described above.

Through the above steps, the aluminum alloy substrate for a magnetic disc according to the present disclosure is manufactured.

The aluminum alloy substrate for a magnetic disc produced as described above is subjected to degreasing, etching, zincate treatment (Zn substitution treatment) as the plating pretreatment (step S 111).

The degreasing is preferably carried out using a commercially available AD-68F (manufactured by Uemura & Co., Ltd.) degreasing liquid or the like at a temperature of 40 to 70° C., a treatment time of 3 to 10 minutes, and a concentration of 200 to 800 mL/L, a temperature of 45 to 65° C., a treatment time of 4 to 8 minutes, and a concentration of 300 to 700 mL/L. When the temperature is less than 40° C., the treatment time is less than 3 minutes, or when the concentration is less than 200 mL/L, a sufficient degreasing effect may not be provided in some cases. In addition, when the temperature exceeds 70° C., the treatment time exceeds 10 minutes, or when the concentration exceeds 800 mL/L, the smoothness of the substrate surface decreases, so that pits may be produced after the plating treatment, thus impairing the smoothness.

The etching is preferably performed under conditions of the temperature of 50 to 75° C., in the present disclosure treatment time of 0.5 to 5 minutes, and in the present disclosure concentration of 20 to 100 mL/L using an etching solution of commercially available AD-107F (manufactured by Uemura & Co., Ltd.), more preferably, under the conditions of the temperature of 55 to 70° C., the treatment time of 0.5 to 3 minutes, and the concentration of 40 to 100 mL/L. When the temperature is less than 50° C., or the treatment time is less than 0.5 minutes, or when the concentration is less than 20 mL/L, a sufficient etching effect may not be provided in some cases. In addition, when the temperature exceeds 75° C. or the treatment time exceeds 5 minutes, or when the concentration exceeds 100 mL/L, the smoothness of the substrate surface decreases, so that pits may be produced after the plating treatment, thus impairing the smoothness. Incidentally, a usual desmutting treatment (immersion in an HNO₃ aqueous solution having a concentration of about 20 to 50% at room temperature for 10 to 120 seconds) may be performed between the etching treatment and the zincate treatment described below.

The zincate treatment may be performed under the conditions of the temperature of 10 to 35° C., the treatment time of 0.1 to 5 minutes, and the concentration of 100 to 500 mL/L using a zincate treatment liquid of commercially available AD-301 F-3 X (manufactured by Uemura & Co., Ltd.), more preferably under the conditions of the temperature of 15 to 30° C., the treatment time of 0.1 to 2 minutes, and the concentration of 200 to 400 mL/L. In the case where the temperature is less than 10° C. or when the treatment time is less than 0.1 min, or when the concentration is less than 100 mL/L, the zincate film becomes nonuniform, so that the conventional pits may be produced after the plating treatment, thus impairing the smoothness. In the case where the temperature exceeds 35° C., the treatment time exceeds 5 minutes, or the concentration exceeds 500 mL/L, the zincate film becomes nonuniform, so that the conventional pits may be produced after the plating treatment, thus impairing the smoothness.

Further, Ni—P electroless plating is applied as a surface treatment to the surface of the aluminum alloy substrate subjected to a zincate treatment, after which the surface is polished (step S 112 ). The Ni—P plating treatment in electroless plating is preferably carried out by plating using a commercially available Nimden HDX (manufactured by Uemura & Co., Ltd.) plating solution at the temperature of 80 to 95° C., the treatment time of 30 to 180 minutes, and the Ni concentration of 3 to 10 g/L, more preferably at the temperature of 85 to 95° C., the treatment time of 60 to 120 minutes, and the Ni concentration of 4 to 9 g/L. In the case where the temperature is lower than 80° C. or the Ni concentration is less than 3 g/L, the growth rate of the plating is slow and productivity may be lowered in some cases. When the treatment time is less than 30 minutes, defects may occur on the plated surface, and the smoothness of the plated surface may be deteriorated. In the case where the temperature exceeds 95° C. or the Ni concentration exceeds 10 g/L, the plating grows unevenly, so that the smoothness of the plating may decrease. When the processing time exceeds 180 minutes, productivity may be lowered in some cases.

Through those plating pretreatments and Ni—P plating, the surface-treated aluminum alloy substrate for the magnetic disc according to the present disclosure is provided. Finally, a magnetic material is attached to the surface subjected to the surface plating treatment by sputtering to obtain a magnetic disc (step S 113).

Although each of the above-described processes is associated with the formation of the Mg-based oxide and the oxidation of Be of the surface layer, the characteristics of the aluminum alloy substrate for a magnetic disc according to the present disclosure are greatly affected by the heating and holding step of the molten aluminum alloy at step S102, the casting stage in step S103, and the straightening heat treatment in step S110. As described above, in the heating and holding step of the molten aluminum alloy, in order to regulate the amount of the Mg-based oxide, the molten aluminum alloy is held in the holding furnace at the holding temperature in the range of 700 to 850° C. for 0.5 hour or longer and less than 6.0 hours, the time period from the end of the molten metal holding step to the start of the casting step is 0.3 hour or less, and the time from the start of the molten metal holding step to the start of the casting step is 6.0 hours or less. In the casting process, the casting process is performed at the temperature of the molten metal at the start of casting being 700 to 850° C. By holding and casting the molten metal under such conditions, the production of the Mg-based oxide is suppressed, which may suppress the formation of micropits. In addition, as described above, in the straightening heat treatment, in order to obtain a desired segregation state of Be at the surface layer, it is necessary to raise the temperature above 150° C. to a holding temperature in the range from 200 to 400° C. by 20.0° C/min or more, a heating and holding step of heating the disc blank at a heating rate, a heating holding step of heating and holding the disc blank at a holding temperature for 5 to 15 minutes, and a cooling and temperature-lowering stage of cooling the disc blank at a temperature falling rate of 20.0° C/min or more from the holding temperature to 150° C. Performing heat treatment under such conditions suppresses the segregation of Be at the surface layer, making it possible to prevent the formation of micropits.

### EXAMPLES

The following describes the present disclosure in more details by way of examples, which do not restrict the present disclosure.

First, each alloy having the composition shown in Table 1 was melted in accordance with a conventional method to obtain a molten aluminum alloy (step S101).

TABLE 1

| | | Composition (mass %) | | | | | | | |
|---|---|---|---|---|---|---|---|---|---|
| | Alloy | | | | | | | | Al + unavoidable |
| | No. | Mg | Cu | Zn | Cr | Fe | Si | Be | impurities |
| Examples | 1 | 5.3 | 0.148 | 0.05 | 0.020 | 0.020 | 0.023 | 0.00030 | balance |
| | 2 | 5.7 | 0.088 | 0.47 | 0.090 | 0.023 | 0.015 | 0.00190 | balance |
| | 3 | 4.6 | 0.023 | 0.59 | 0.070 | 0.017 | 0.023 | 0.00030 | balance |
| | 4 | 4.5 | 0.046 | 0.11 | 0.070 | 0.016 | 0.001 | 0.00001 | balance |
| | 5 | 7.3 | 0.003 | 0.19 | 0.010 | 0.059 | 0.029 | 0.00062 | balance |
| | 6 | 8.7 | 0.034 | 0.33 | 0.110 | 0.018 | 0.059 | 0.00170 | balance |
| | 7 | 9.8 | 0.028 | 0.39 | 0.290 | 0.001 | 0.016 | 0.00010 | balance |
| Comparative | 8 | 10.3 | 0.084 | 0.39 | 0.080 | 0.017 | 0.025 | 0.00020 | balance |
| Examples | 9 | 4.8 | 0.167 | 0.25 | 0.150 | 0.011 | 0.019 | 0.00021 | balance |
| | 10 | 5.0 | 0.082 | 0.68 | 0.080 | 0.025 | 0.012 | 0.00020 | balance |
| | 11 | 4.9 | 0.008 | 0.25 | 0.340 | 0.017 | 0.017 | 0.00018 | balance |
| | 12 | 5.6 | 0.079 | 0.34 | 0.030 | 0.065 | 0.022 | 0.00023 | balance |
| | 13 | 5.8 | 0.011 | 0.30 | 0.100 | 0.011 | 0.065 | 0.00020 | balance |
| | 14 | 5.7 | 0.032 | 0.44 | 0.100 | 0.020 | 0.025 | 0.00250 | balance |
| | 15 | 4.0 | 0.023 | 0.47 | 0.070 | 0.023 | 0.023 | 0.00027 | balance |
| | 16 | 5.0 | 0.001 | 0.16 | 0.140 | 0.012 | 0.014 | 0.00021 | balance |
| | 17 | 5.4 | 0.091 | 0.03 | 0.010 | 0.021 | 0.019 | 0.00020 | balance |
| | 18 | 5.1 | 0.037 | 0.20 | 0.005 | 0.022 | 0.014 | 0.00023 | balance |
| | 19 | 5.8 | 0.037 | 0.25 | 0.070 | 0.017 | 0.023 | 0.00000 | balance |
| | 20 | 5.7 | 0.011 | 0.40 | 0.100 | 0.023 | 0.016 | 0.00024 | balance |
| | 21 | 5.3 | 0.028 | 0.33 | 0.130 | 0.023 | 0.016 | 0.00030 | balance |
| | 22 | 5.8 | 0.023 | 0.34 | 0.020 | 0.022 | 0.023 | 0.00024 | balance |
| | 23 | 5.7 | 0.032 | 0.40 | 0.100 | 0.017 | 0.016 | 0.00018 | balance |
| | 24 | 5.8 | 0.011 | 0.46 | 0.070 | 0.022 | 0.023 | 0.00030 | balance |
| | 25 | 5.3 | 0.023 | 0.33 | 0.020 | 0.023 | 0.017 | 0.00024 | balance |
| | 26 | 5.8 | 0.037 | 0.25 | 0.070 | 0.017 | 0.017 | 0.00030 | balance |
| | 27 | 5.7 | 0.028 | 0.46 | 0.130 | 0.022 | 0.017 | 0.00024 | balance |
| | 28 | 5.7 | 0.060 | 0.49 | 0.130 | 0.013 | 0.017 | 0.00020 | balance |
| | 29 | 4.5 | 0.084 | 0.46 | 0.120 | 0.021 | 0.010 | 0.00020 | balance |
| | 30 | 5.3 | 0.011 | 0.30 | 0.100 | 0.011 | 0.017 | 0.00018 | balance |
| | 31 | 5.0 | 0.079 | 0.40 | 0.130 | 0.012 | 0.019 | 0.00018 | balance |
| | 32 | 5.3 | 0.062 | 0.46 | 0.030 | 0.010 | 0.015 | 0.00010 | balance |
| | 33 | 4.7 | 0.032 | 0.44 | 0.100 | 0.020 | 0.025 | 0.00020 | balance |
| | 34 | 5.3 | 0.041 | 0.49 | 0.010 | 0.025 | 0.010 | 0.00024 | balance |
| | 35 | 4.6 | 0.030 | 0.44 | 0.100 | 0.020 | 0.025 | 0.00020 | balance |
| | 36 | 5.4 | 0.040 | 0.49 | 0.010 | 0.025 | 0.010 | 0.00024 | balance |

Next, the molten aluminum alloy was heated and held in the holding furnace under the conditions shown in Table 2 (step S102). Next, the molten aluminum alloy heated and held was cast by a semi-continuous casting method (DC casting method) to prepare an ingot (step S103).

TABLE 2

| | | Casting conditions | | | | |
|---|---|---|---|---|---|---|
| | | Heating | | | Time from | |
| | | temperature | Time for | Time from | holding of | Temperature of |
| | | for molten | holding molten | molten metal | molten metal | molten metal |
| | | metal in | metal in | to start of | to start of | upon starting |
| | Alloy | holding furnace | holding furnace | casting | casting | casting |
| | No. | (° C.) | (hr) | (hr) | (hr) | (° C.) |
| Examples | 1 | 806 | 5.9 | 0.1 | 6.0 | 798 |
| | 2 | 778 | 0.5 | 0.3 | 0.8 | 768 |
| | 3 | 705 | 4.6 | 0.1 | 4.7 | 702 |
| | 4 | 776 | 3.0 | 0.1 | 3.1 | 770 |
| | 5 | 842 | 2.0 | 0.1 | 2.1 | 830 |
| | 6 | 788 | 3.4 | 0.2 | 3.6 | 782 |
| | 7 | 766 | 1.2 | 0.1 | 1.3 | 760 |
| Comparative | 8 | 817 | 1.5 | 0.2 | 1.7 | 808 |
| Examples | 9 | 813 | 3.0 | 0.1 | 3.1 | 802 |
| | 10 | 798 | 4.6 | 0.2 | 4.8 | 791 |
| | 11 | 776 | 1.5 | 0.2 | 1.7 | 771 |
| | 12 | 850 | 2.1 | 0.2 | 2.3 | 838 |
| | 13 | 786 | 3.0 | 0.2 | 3.2 | 774 |
| | 14 | 787 | 1.5 | 0.2 | 1.7 | 777 |
| | 15 | 750 | 3.0 | 0.2 | 3.2 | 745 |
| | 16 | 776 | 3.4 | 0.2 | 3.6 | 770 |
| | 17 | 754 | 4.6 | 0.1 | 4.7 | 750 |
| | 18 | 805 | 3.4 | 0.1 | 3.5 | 798 |
| | 19 | 750 | 2.1 | 0.1 | 2.2 | 745 |
| | 20 | 863 | 3.4 | 0.2 | 3.6 | 830 |
| | 21 | 685 | 3.4 | 0.2 | 3.6 | 665 |
| | 22 | 754 | 6.5 | 0.2 | 6.7 | 745 |
| | 23 | 754 | 0.2 | 0.2 | 0.4 | 745 |
| | 24 | 776 | 5.9 | 0.5 | 6.4 | 761 |
| | 25 | 805 | 5.8 | 0.6 | 6.4 | 802 |
| | 26 | 883 | 4.6 | 0.1 | 4.7 | 864 |
| | 27 | 702 | 2.1 | 0.3 | 2.4 | 687 |
| | 28 | 825 | 1.5 | 0.1 | 1.6 | 815 |
| | 29 | 750 | 3.0 | 0.1 | 3.1 | 745 |
| | 30 | 776 | 1.5 | 0.2 | 1.7 | 758 |
| | 31 | 821 | 3.0 | 0.2 | 3.2 | 810 |
| | 32 | 767 | 2.1 | 0.1 | 2.2 | 761 |
| | 33 | 798 | 1.5 | 0.2 | 1.7 | 761 |
| | 34 | 805 | 3.4 | 0.2 | 3.6 | 802 |
| | 35 | 799 | 5.9 | 0.3 | 6.2 | 752 |
| | 36 | 805 | 6.2 | 0.5 | 6.7 | 800 |

The ingot was subjected to face milling on both sides of 15 mm, and alloys other than alloy No. 2 were homogenized at 510° C. for 3 hours (step S104). Next, hot rolling was performed at a hot rolling start temperature of 460° C. and a hot rolling end temperature of 340° C. to obtain a hot rolled plate having a thickness of 3.0 mm (step S 105). The hot-rolled plates other than that of alloy No. 7 were rolled to a plate thickness of 1.0 mm by cold rolling (rolling rate of 67%) without intermediate annealing to prepare a final rolled plate (step S106). For alloy No. 7, the first cold rolling (rolling rate of 33%) was applied first and then intermediate annealing was carried out at 300° C. for 2 hours by using a batch type annealing furnace. Next, it was rolled to a plate thickness of 1.0 mm by a second cold rolling (reduction of 50%) to obtain a final rolled plate (step S106). The thus obtained aluminum alloy plate was punched into an annular shape having an outer diameter of 96 mm and an inner diameter of 24 mm to prepare an annular aluminum alloy plate (step S 107).

Pressure flattening and annealing at 400° C. for 3 hours was performed on the annular aluminum alloy plate obtained as described above under a pressure of 1.5 MPa to form a disc blank (step S 108). Further, the end face of the disc blank was subjected to polishing to have an outer diameter of 95 mm and an inner diameter of 25 mm, and further subjected to polishing (polishing) for polishing the surface by 10 μm (step S 109). Next, heating was carried out under the conditions of Table 3 to obtain an aluminum alloy substrate (step S110).

TABLE 3

| | | Heating conditions after polishing | | | |
|---|---|---|---|---|---|
| | | Rate of temperature rise | | | Rate of temperature fall to |
| | | to holding temperature of | Holding | Holding | 150° C. from holding |
| | Alloy | 200-400° C. from 150° C. | temperature | time | temperature of 200-400° C. |
| | No. | (° C./min) | (° C.) | (min) | (° C./min) |
| Examples | 1 | 32.5 | 200 | 5 | 34.0 |
| | 2 | 38.8 | 250 | 8 | 40.7 |
| | 3 | 31.3 | 385 | 5 | 35.3 |
| | 4 | 33.1 | 300 | 15 | 33.3 |
| | 5 | 50.6 | 400 | 8 | 20.1 |
| | 6 | 32.5 | 340 | 13 | 33.3 |
| | 7 | 20.1 | 300 | 8 | 55.3 |
| Comparative | 8 | 32.5 | 300 | 8 | 33.3 |
| Examples | 9 | 31.9 | 340 | 8 | 33.3 |
| | 10 | 33.1 | 340 | 8 | 35.3 |
| | 11 | 31.3 | 300 | 8 | 35.3 |
| | 12 | 31.9 | 340 | 8 | 34.0 |
| | 13 | 31.9 | 340 | 8 | 35.3 |
| | 14 | 31.9 | 300 | 8 | 34.0 |
| | 15 | 30.0 | 340 | 8 | 33.3 |
| | 16 | 30.6 | 300 | 8 | 33.3 |
| | 17 | 33.1 | 300 | 8 | 34.0 |
| | 18 | 31.9 | 300 | 8 | 35.3 |
| | 19 | 33.1 | 305 | 8 | 34.0 |
| | 20 | 31.9 | 305 | 8 | 34.0 |
| | 21 | 32.5 | 300 | 8 | 33.3 |
| | 22 | 33.1 | 305 | 8 | 34.0 |
| | 23 | 31.9 | 305 | 8 | 33.3 |
| | 24 | 33.1 | 300 | 8 | 33.3 |
| | 25 | 31.9 | 305 | 8 | 34.0 |
| | 26 | 33.1 | 300 | 8 | 33.3 |
| | 27 | 32.5 | 305 | 8 | 34.0 |
| | 28 | 15.6 | 380 | 14 | 34.0 |
| | 29 | 32.5 | 420 | 11 | 35.3 |
| | 30 | 31.9 | 130 | 8 | 33.3 |
| | 31 | 31.9 | 300 | 19 | 33.3 |
| | 32 | 32.5 | 340 | 30 | 33.3 |
| | 33 | 31.9 | 200 | 2 | 33.3 |
| | 34 | 32.5 | 380 | 12 | 16.7 |
| | 35 | 31.9 | 340 | 8 | 34.0 |
| | 36 | 31.9 | 340 | 8 | 35.3 |

Thereafter, plating pretreatment was applied to the aluminum alloy substrate for magnetic disc subjected to straightening heat treatment. Specifically, first, the aluminum alloy substrate for a magnetic disc was immersed in a degreasing solution (concentration: 550 mL/L) of AD-68F (manufactured by Uemura Kogyo) at 60° C. for 5 minutes to degrease the surface. Next, the surface was etched by immersing in an etching solution (concentration: 70 mL/L) of AD-107F (manufactured by Uemura & Co., Ltd.) at 65° C. for 1 minute. Further, the surface was immersed in a 30% HNO₃ aqueous solution at room temperature for 20 seconds and the surface was desmutted. After adjusting the surface condition in this manner, the aluminum alloy substrate was immersed in a zincate treatment solution (concentration: 300 mL/L) of AD-301 F-3 X (manufactured by Uemura & Co., Ltd.) at 20° C. for 0.5 minutes to form a zincate (step S 111). The zincate treatment was performed twice in total, and the surface was peeled off by dipping in a 30% HNO3 aqueous solution at room temperature for 20 seconds during the zincate treatment. As described above, the plating pretreatment was completed. Next, an Ni—P plating layer with a thickness of 18 μm was formed on the surface of the aluminum alloy substrate subjected to the zincate treatment using an electroless Ni—P plating treatment liquid (Nimden HDX (manufactured by Uemura & Co., Ltd.), Ni concentration 7 g/L)) electroless plating was carried out. The electroless Ni—P plating treatment was performed at a temperature of 92° C. for a treatment time of 160 minutes. Finally, the plated surface was finish polished with a feather cloth at a polishing amount of 6 μm (step S 112). In this manner, a surface-treated aluminum alloy substrate for a magnetic disc was prepared.

The following evaluation was carried out on an aluminum alloy plate after the cold rolling step (step S106), an aluminum alloy substrate for a magnetic disc after the straightening heat treatment (step S110) after polishing, and a surface-treated aluminum alloy substrate for a magnetic disc after the surface (Ni—P) plating (with polishing) (step S112). As shown in Table 4, for Comparative Example 30 using alloy No. 30, since the temperature during heating after polishing was low, alloy No. 3 was used. Comparative Example 33 using 33, since the holding time during heating after polishing was short, the processing strain was not completely removed in both Examples. As a result, the substrate was deformed during heating after the plating process, and the constituent requirements for “for magnetic disc” could not be satisfied, so the following evaluations were not made (see Table 4).

TABLE 4

| | | | | | | | | Smoothness of plated surface | | |
|---|---|---|---|---|---|---|---|---|---|---|
| | | | | | | | | Distribution of | Distribution of | |
| | | | | | | | | plated pits | plated pits | |
| | | | | | | | | with maximum | with maximum | |
| | | | | Mg-based oxide | | | | diameter of | diameter of | |
| | | Strength | | Amount of | | Segregation state of | | 1 μm or more | 0.5 μm or more | |
| | | Yield | | Mg-based | | Be at surface layer | | (conventional | and less than | |
| | Alloy | strength | | oxide | | (I_{Be}/I_{bulk}) × (C_{Be}) | | pits) | 1 μm (micropits) | |
| | No. | (MPa) | Evaluation | (ppm) | Evaluation | (mass %) | Evaluation | (pieces/mm²) | (pieces/mm²) | Evaluation |
| Examples | 1 | 135 | ⊚ | 23 | ⊚ | 0.0250 | ⊚ | 0 | 0 | ⊚ |
| | 2 | 142 | ⊚ | 11 | ⊚ | 0.0950 | ⊚ | 0 | 1 | ◯ |
| | 3 | 121 | ⊚ | 2 | ⊚ | 0.0200 | ⊚ | 0 | 0 | ⊚ |
| | 4 | 121 | ⊚ | 5 | ⊚ | 0.0002 | ⊚ | 0 | 0 | ⊚ |
| | 5 | 158 | ⊚ | 45 | ⊚ | 0.0600 | ⊚ | 1 | 0 | ◯ |
| | 6 | 162 | ⊚ | 27 | ⊚ | 0.0700 | ⊚ | 0 | 0 | ⊚ |
| | 7 | 168 | ⊚ | 32 | ⊚ | 0.0100 | ⊚ | 1 | 0 | ◯ |
| Comparative | 8 | 171 | ⊚ | 28 | ⊚ | 0.0150 | ⊚ | 6 | 0 | X |
| Examples | 9 | 123 | ⊚ | 8 | ⊚ | 0.0100 | ⊚ | 4 | 0 | X |
| | 10 | 125 | ⊚ | 5 | ⊚ | 0.0150 | ⊚ | 5 | 0 | X |
| | 11 | 124 | ⊚ | 8 | ⊚ | 0.0150 | ⊚ | 23 | 0 | X |
| | 12 | 137 | ⊚ | 5 | ⊚ | 0.0100 | ⊚ | 28 | 0 | X |
| | 13 | 138 | ⊚ | 8 | ⊚ | 0.0100 | ⊚ | 8 | 0 | X |
| | 14 | 139 | ⊚ | 5 | ⊚ | 0.1150 | X | 0 | 3 | X |
| | 15 | 112 | X | 3 | ⊚ | 0.0100 | ⊚ | 0 | 0 | ⊚ |
| | 16 | 127 | ⊚ | 8 | ⊚ | 0.0100 | ⊚ | 3 | 0 | X |
| | 17 | 132 | ⊚ | 7 | ⊚ | 0.0150 | ⊚ | 4 | 0 | X |
| | 18 | 130 | ⊚ | 8 | ⊚ | 0.0100 | ⊚ | 5 | 0 | X |
| | 19 | 138 | ⊚ | 62 | X | 0.0000 | ⊚ | 0 | 12 | X |
| | 20 | 138 | ⊚ | 58 | X | 0.0200 | ⊚ | 0 | 10 | X |
| | 21 | 129 | ⊚ | 5 | ⊚ | 0.0100 | ⊚ | 11 | 0 | X |
| | 22 | 139 | ⊚ | 63 | X | 0.0200 | ⊚ | 0 | 15 | X |
| | 23 | 136 | ⊚ | 8 | ⊚ | 0.0200 | ⊚ | 10 | 0 | X |
| | 24 | 138 | ⊚ | 59 | X | 0.0100 | ⊚ | 0 | 8 | X |
| | 25 | 132 | ⊚ | 69 | X | 0.0200 | ⊚ | 0 | 7 | X |
| | 26 | 138 | ⊚ | 82 | X | 0.0200 | ⊚ | 0 | 16 | X |
| | 27 | 137 | ⊚ | 5 | ⊚ | 0.0100 | ⊚ | 12 | 0 | X |
| | 28 | 139 | ⊚ | 8 | ⊚ | 0.1150 | X | 0 | 5 | X |
| | 29 | 122 | ⊚ | 7 | ⊚ | 0.1250 | X | 0 | 6 | X |
| | 30 | — | — | — | — | — | — | — | — | — |
| | 31 | 128 | ⊚ | 7 | ⊚ | 0.1100 | X | 0 | 4 | X |
| | 32 | 129 | ⊚ | 8 | ⊚ | 0.1200 | X | 0 | 5 | X |
| | 33 | — | — | — | — | — | — | — | — | — |
| | 34 | 132 | ⊚ | 8 | ⊚ | 0.1100 | X | 0 | 5 | X |
| | 35 | 125 | ⊚ | 52 | X | 0.0100 | ⊚ | 0 | 6 | X |
| | 36 | 132 | ⊚ | 73 | X | 0.0200 | ⊚ | 0 | 10 | X |

Strength

The aluminum alloy plate after the cold rolling step (step S106) was heated at 400° C. for 3 hours, and then the yield strength (in the direction along the rolling direction) of JIS No. 5 test sample cut out along the rolling direction was measured using an Instron type tensile tester AG-50kNG manufactured by Shimadzu Corporation. The measurement conditions were a gauge distance of 50 mm and a crosshead speed of 10 mm/min. As evaluation criteria, those with a yield strength of 120 MPa or more were rated as excellent (mark ⊚), and those with a yield strength of less than 120 MPa were judged as bad (mark ×). The results are shown in Table 4.

Amount of Mg-based oxide of aluminum alloy substrate for magnetic disc

The amount of the Mg-based oxide of the aluminum alloy substrate for magnetic disc after the straightening heat treatment (step S110) was measured by the iodine methanol method, that is, the oxide extraction method. As evaluation criteria, those having an Mg-based oxide amount of 50 ppm or less were evaluated as excellent (mark ⊚), and those exceeding 50 ppm were evaluated as poor (mark ×). The results are shown in Table 4.

Segregation state at the surface layer of aluminum alloy substrate for magnetic disc

Be along the depth direction of the surface of the aluminum alloy substrate for magnetic disc after the straightening heat treatment (step S110) was analyzed by the GDS. Specifically, as described above, the oxidation state of Be in the surface layer of the aluminum alloy substrate was evaluated by measuring the maximum emission intensity of Be and the average Be intensity inside the base material. The GDS analysis was carried out using JY-5000 RF, a device manufactured by Horiba Ltd. Measurement conditions for the GDS were a pressure 600 Pa after replacing the argon gas, an output of 30 W, a module 700, a phase 300, and an anode diameter of 4 mmφ. The maximum peak height of Be in sputtering from the surface of the measurement sample to the depth of 2.0 μm was taken as the maximum emission intensity. Also, the average height of Be in the depth of 1.5 to 2.0 μm from the surface of the measurement sample was taken as the average intensity. Measurement samples with (I_{Be}/I_{bulk})×(C_{Be}) of 0.1000% or less, the product of the ratio (I_{Be}/I_{bulk}) of the maximum emission intensity (I_{Be}) of Be measured in this way to the average Be intensity (I_{bulk}) inside the base material of the aluminum alloy plate, and the Be concentration (C_{Be}), were excellent (mark ⊚), and measurement samples with (I_{Be}/I_{bulk})×(C_{Be}) over 0.1000% were judged as poor (mark ×). The results are shown in Table 4.

Smoothness of a surface-treated aluminum alloy substrate for a magnetic disc

The quantities of conventional pits and micropits on the surface of the surface-treated aluminum alloy substrate for the magnetic disc after Ni—P plating and polishing (step S112) were determined. With respect to the conventional pits, the quantity of conventional pits having a size with a maximum diameter of 1 μm or more was measured with an observation field of 1 mm² at 1000× magnification by an optical microscope, and the quantity per unit area (number density: pieces/mm²) is obtained. With respect to micropits, the quantity of micropits having a size with a maximum diameter of 0.5 μm or more and less than 1 μm was measured with an observation field of 1 mm² at 2000× magnification by SEM and the quantity of micropits per unit area (number density: number/mm²) was obtained. Here, in both conventional pits and micropits, the longest diameter means the largest one observed as the length of each pit. In addition, the upper limit of the maximum diameter of the conventional pits is not limited, but those having a diameter of 10 μm or more were not observed. In the case of micropits, since those having a maximum diameter of less than 0.5 μm were not observed, they were excluded. Incidentally, both the conventional pits and the micropits were counted as one, as well as the case where the entire pits were present in the observation field of 1 mm², as well as those in which only the pits were partly observed. As evaluation criteria, when the number density of conventional pits and micropits is 0 mm², excellent (mark ⊚) is taken, when one or both are 1 mm² is good (mark ∘) and one or both were 2 pieces/mm² or more was judged as poor (mark ×). The results are shown in Table 4.

As shown in Table 4, in Examples 1 to 7, the amount of the Mg-based oxide and the segregation state of Be at the surface layer were excellent, and an aluminum alloy substrate for a magnetic disc excellent in smoothness and strength of the plated surface was obtained. In contrast, in each of Comparative Examples 8 to 29, 31, 32, and 34 to 36, since the constituent elements other than those specified in the present disclosure were included, the smoothness of the plated surface was poor.

That is, in Comparative Example 8, since the Mg content was too large, a lot of coarse Al—Mg intermetallic compounds were produced, and this intermetallic compound was dropped off in the plating pretreatment and a large depression was formed on the surface of the aluminum alloy substrate. As a result, the conventional pits tended to be formed on the plated surface, making the smoothness of the plated surface poor.

In Comparative Example 9, the excessive Cu content caused a lot of coarse Al—Cu—Mg—Zn intermetallic compounds to be produced, and this intermetallic compound was dropped off in the plating pretreatment to form a large depression. As a result, the conventional pits tended to be formed on the plated surface, making the smoothness of the plated surface poor.

In Comparative Example 10, a lot of coarse Al—Cu—Mg—Zn intermetallic compounds were produced due to too much Zn content, and the intermetallic compounds were dropped off in the plating pretreatment to form a large depression. As a result, the conventional pits tended to be formed on the plated surface, making the smoothness of the plated surface poor.

In Comparative Example 11, the excessive Cr content caused a lot of coarse Al—Cr intermetallic compounds to be produced, and this intermetallic compound was dropped off in the plating pretreatment and a large depression was produced on the surface of the aluminum alloy substrate. As a result, the conventional pits tended to be formed on the plated surface, making the smoothness of the plated surface poor.

In Comparative Example 12, since the Fe content was too large, a lot of coarse Al—Fe intermetallic compounds were produced, and this intermetallic compound was dropped off in the plating pretreatment and a large depression was produced on the surface of the aluminum alloy substrate. As a result, the conventional pits tended to be formed on the plated surface, making the smoothness of the plated surface poor.

In Comparative Example 13, since the Si content was too large, many coarse Mg—Si intermetallic compounds were produced, and this intermetallic compound was dropped off in the plating pretreatment, and a large depression was produced on the surface of the aluminum alloy substrate. As a result, the conventional pits tended to be formed on the plated surface, making the smoothness of the plated surface poor.

In Comparative Example 14, the excessively large Be content caused the segregation of Be in the straightening heat treatment after polishing. (I_{Be}/I_{bulk})×(C_{Be}) exceeded the upper limit value of 0.1000% to 0.1150%. Consequently, segregation occurred in the straightening heat treatment after polishing, and a thick Al/Mg/Be oxide was formed. As a result, micropits tended to be formed on the plated surface, making the smoothness of the plated surface poor.

In Comparative Example 15, the yield strength was low because the Mg content was too small. As a result, the strength was poor.

In Comparative Example 16, since the Cu content was too small, the zincate film became nonuniform. As a result, the conventional pits tended to be formed on the plated surface, making the smoothness of the plated surface poor.

In Comparative Example 17, the zincate film became nonuniform due to too little Zn content. As a result, the conventional pits tended to be formed on the plated surface, making the smoothness of the plated surface poor.

In Comparative Example 18, since the Cr content was too small, the crystal grains of the aluminum alloy plate became coarse and the adhesion of the plating deteriorated. As a result, the conventional pits tended to be formed on the plated surface, making the smoothness of the plated surface poor.

In Comparative Example 19, since the Be content was too small, many Mg-based oxides were produced. As a result, micropits tended to be formed on the plated surface, making the smoothness of the plated surface poor.

In Comparative Example 20, since the heating temperature of the molten metal in the holding furnace was too high, a lot of Mg-based oxides were produced. As a result, micropits tended to be formed on the plated surface, making the smoothness of the plated surface poor.

In Comparative Example 21, a lot of coarse inclusions were produced because the heating temperature of the molten metal in the holding furnace and the temperature of the molten metal at the start of casting were too low, and a lot of large dents and polishing scratches on the surface of the aluminum alloy plate were formed during polishing and plating pretreatment. As a result, the conventional pits tended to be formed on the plated surface, making the smoothness of the plated surface poor.

In Comparative Example 22, since the holding time of the molten metal in the holding furnace was too long, a lot of Mg-based oxides were produced. As a result, micropits tended to be formed on the plated surface, making the smoothness of the plated surface poor.

In Comparative Example 23, since the retention time of the molten metal in the holding furnace was too short, a lot of coarse inclusions remained, and many large depressions and polishing scratches formed on the surface of the aluminum alloy plate during polishing and plating pretreatment. As a result, the conventional pits tended to be formed on the plated surface, making the smoothness of the plated surface poor.

In Comparative Examples 24 and 25, the time from the end of the molten metal holding step to the start of the casting process and the time from the start of the molten metal holding step to the start of the casting step were too long, so that a lot of the Mg-based oxides were produced. As a result, micropits tended to be formed on the plated surface, making the smoothness of the plated surface poor.

In Comparative Example 26, since the heating temperature of the molten metal in the holding furnace and the temperature of the molten metal at the start of casting were too high, a lot of Mg-based oxides were produced. As a result, micropits tended to be formed on the plated surface, making the smoothness of the plated surface poor.

In Comparative Example 27, a lot of coarse inclusions were produced due to the molten metal temperature being too low at the beginning of casting, and many large depressions and polishing scratches formed on the surface of the aluminum alloy plate during polishing and plating pretreatment. As a result, the conventional pits tended to be formed on the plated surface, making the smoothness of the plated surface poor.

In Comparative Example 28, the temperature rise rate (from 100° C. to the holding temperature of 200 to 400° C.) during heating after the polishing process was too slow, so that the segregation of Be occurred in the straightening heat treatment after polishing. (I_{Be}/I_{bulk})×(C_{Be}) exceeded the upper limit value of 0.1000% to 0.1150%. As a result, the Al/Mg/Be oxides on the surface layer became thick, micropits tended to be formed on the plated surface, making the smoothness of the plated surface poor.

In Comparative Example 29, since the holding temperature at the time of heating after polishing was too high, the segregation of Be occurred in the straightening heat treatment after polishing. (I_{Be}/I_{bulk})×(C_{Be}) exceeded the upper limit value of 0.1000% to 0.1250%. Therefore, segregation occurred in the straightening heat treatment after polishing, and the Al/Mg/Be oxide in the surface layer became thick. As a result, micropits tended to be formed on the plated surface, and the smoothness of the plated surface became poor.

In Comparative Examples 31 and 32, the retention time at the time of heating after the polishing process was too long, so the segregation of Be occurred in the straightening heat treatment after polishing. Then, (I_{Be}/I_{bulk})×(C_{Be}) exceeded the upper limit of 0.1000%, 0.1100% in Comparative Example 31, and 0.1200% in Comparative Example 32. Therefore, segregation occurred in the straightening heat treatment after polishing, and the Al/Mg/Be oxide in the surface layer became thick. As a result, micropits tended to be formed on the plated surface, making the smoothness of the plated surface poor.

In Comparative Example 34, the temperature decreasing rate during heating after polishing (retention temperature of 200 to 400° C. to 100° C.) was too late, so that the segregation of Be occurred in the straightening heat treatment after polishing. (I_{Be}/I_{bulk})×(C_{Be}) exceeded the upper limit value of 0.1000% to 0.1100%. As a result, the Al/Mg/Be oxides on the surface layer became thick, micropits tended to be formed on the plated surface, making the smoothness of the plated surface poor.

In Comparative Example 35, since the time from the start of the molten metal holding step to the start of casting was too long, a lot of the Mg-based oxides were produced. As a result, micropits tended to be formed on the plated surface, making the smoothness of the plated surface poor.

In Comparative Example 36, the holding time of the molten metal in the holding furnace, the time from the end of the molten metal holding step to the start of casting and the time from the start of the molten metal holding step to the start of casting were too long, so that a lot of Mg-based oxides were produced. As a result, micropits tended to be formed on the plated surface, making the smoothness of the plated surface poor.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of. Japanese Patent Application No. 2015-148298, filed on Jul. 28, 2015, and Japanese Patent Application No. 2016-143017, filed on Jul. 21, 2016, of which the entirety of the disclosures is incorporated by reference herein.

### INDUSTRIAL APPLICABILITY

The present disclosure may provide an aluminum alloy substrate for a magnetic disc and a surface-treated aluminum alloy substrate for a magnetic disc, both of which are excellent in smoothness of the plated surface and strength, and thus is excellent in industrial applicability.

1. An aluminum alloy substrate for a magnetic disc, comprising:
an aluminum alloy consisting of Mg: 4.5 to 10.0 mass %, Be: 0.00001 to 0.00200 mass %, Cu: 0.003 to 0.150 mass %, Zn: 0.05 to 0.60 mass %, Cr: 0.010 to 0.300 mass %, Si: 0.060 mass % or less, and Fe: 0.060 mass % or less, with a balance being Al and unavoidable impurities, an amount of an Mg-based oxide being 50 ppm or less, (I_{Be}/I_{bulk})×(C_{Be})≤0.1000 mass % where (I_{Be}) is a maximum optical emission intensity of Be in a surface depth direction using a glow discharge optical emission spectrometer(GDS) prior to performing a plating pretreatment, (I_{bulk}) is a mean optical emission intensity of Be in an interior of a base material of the aluminum alloy prior to performing a plating pretreatment, and (C_{Be}) is an amount of the Be.

2. A method of manufacturing an aluminum alloy substrate for a magnetic disc according to claim 1, comprising:
a preparing step of preparing a molten metal of the aluminum alloy;
a molten-metal holding step of heating and holding the prepared molten metal of the aluminum alloy;
a casting step of casting the heated and held molten metal;
a hot rolling step of hot rolling an ingot;
a cold rolling step of cold rolling a hot rolled plate;
a machining step of machining the cold rolled plate into an annular disc;
a pressure flattening and annealing step of pressurizing and flattening the annular disc to yield a disc blank;
a cutting and polishing step of cutting and polishing the disc blank; and
a straightening heat treatment step of cutting and polishing the cut and polished disc blank,
wherein
in the molten-metal holding step, the molten metal of the aluminum alloy is heated and held in a holding furnace at a holding temperature in a range of 700 to 850° C. for 0.5 and more and less than 6.0 hours, a time from end of the molten-metal holding step to start of the casting step being 0.3 hours or less, a time from start of the molten-metal holding step to start of the casting step is 6.0 hours or less,
in the casting step, the molten metal is cast with a temperature of the molten metal at start of the casting being set to 700 to 850° C., and
the straightening heat treatment step includes a heating and temperature raising stage of heating the disc blank at a temperature raising rate of 20.0° C/min or more from 150° C. to the holding temperature in the range to 200 to 400° C., a heating and holding stage of heating and holding the disc blank at the holding temperature for 5 to 15 minutes, and a cooling and temperature-lowering stage of cooling the disc blank at a temperature falling rate of 20.0° C/min or more from the holding temperature to 150° C.

3. A magnetic disc wherein plating and a magnetic material are provided on the aluminum alloy substrate for the magnetic disc according to claim 1.
